(19) United States
(12) Patent Application Publication
(10) Pub. No.: US 2014/0324872 A1
(43) Pub. Date: Oct. 30, 2014

(54) ADDRESS BOOK MAINTENANCE METHOD AND GROUP ADDRESS BOOK MANAGEMENT PLATFORM

(71) Applicant: TENCENT TECHNOLOGY (SHENZHEN) COMPANY LIMITED, Shenzhen (CN)

(72) Inventor: Zhaohua Lu, Shenzhen (CN)

(73) Assignee: TENCENT TECHNOLOGY (SHENZHEN) COMPANY LIMITED, Shenzhen (CN)

(21) Appl. No.: 14/250,861

(22) Filed: Apr. 11, 2014

Related U.S. Application Data
(63) Continuation of application No. PCT/CN2012/081671, filed on Sep. 20, 2012.

(30) Foreign Application Priority Data
Oct. 14, 2011 (CN) 201110311477.8

(51) Int. Cl. G06F 17/30

(52) U.S. Cl. CPC G06F 17/30699
USPC 707/740

(57) ABSTRACT

Disclosed are an address book maintenance method and platform. The method includes: creating at least one group address book, and assigning a group ID to the at least one group address book; and upon receiving a request for downloading and updating a user address book form a user equipment, updating the user address book according to the at least one group address book. With the technical solutions, users are capable of quickly and conveniently managing and updating address books.

This application is a continuation of International Application No. PCT/CN2012/081671, filed Sep. 20, 2012, and claims priority to Chinese Patent Application No. 201110311477.8, filed before the Chinese Patent Office on Oct. 14, 2011 and entitled “ADDRESS BOOK MAINTENANCE METHOD AND GROUP ADDRESS BOOK MANAGEMENT PLATFORM”, the entire contents of each of which is incorporated herein by reference in its entirety.

### TECHNICAL FIELD

The present disclosure relates to the field of address book technologies, and in particular, to an address book maintenance method and a group address book management platform.

### BACKGROUND

With rapid development of the information-based society, information interaction between people is becoming more and more convenient and diversified. In addition to traditional information interaction manners such as letter, fax, and telephone call, information interaction platforms such as currently prevailing instant messaging tools (for example, QQ, MSN, or Baidu Hi), Weibo(China's Twitter-like microblogging site), such social networking service (SNS) as Renren Network or Kaixin Network, and email provides, advantages such as instantness, large communication range, and low communication cost. Therefore, these information interaction platforms have been widely used in people's daily life.

Diversified information interaction platforms bring great convenience to information exchange and communication for people, and also require users to memorize diversified contact information, such as QQ account, Weibo account, email account, and MSN account. Generally, users record and manage such contact information over an address book.

### SUMMARY

Embodiments of the present disclosure provide an address book maintenance method and a group address book management platform. The technical solutions are as follows:

An address book maintenance method includes:

creating, by a group address book management platform, at least one group address book, and assigning a group ID to the at least one group address book; and

upon receiving a request for downloading and updating a user address book from a user equipment, updating, by the group address book management platform, the user address book according to the at least one group address book.

A group address book management platform includes a creating module and an updating module.

The creating module is configured to create at least one group address book, and assign a group ID to the at least one group address book.

The updating module is configured to: upon receiving a request for downloading and updating a user address book from a user equipment, update the user address book according to the at least one group address book.

According to the technical solutions disclosed in the present disclosure, at least one group address book is created, and a group ID is assigned to the at least one group address book; after a request for downloading and updating a user address book is received from a user equipment, the user address book is updated according to the created at least one group address book, such that users can quickly and conveniently manage and update the address book. In this way, a solution of downloading and synchronizing at least one group address book to the address book of such a user equipment as mobile phone, tablet computer, and personal computer.

### BRIEF DESCRIPTION OF THE DRAWINGS

For a better understanding of the technical solutions in the embodiments of the present disclosure, the accompanying drawings for illustrating the embodiments are briefly described below. Apparently, the accompanying drawings in the following description illustrate only some embodiments of the present disclosure, and persons of ordinary skill in the art can derive other accompanying drawings from these accompanying drawings without any creative efforts.

FIG. 1 is a flowchart of an address book maintenance method according to an embodiment of the present disclosure;

FIG. 2 is a network architectural diagram according to an embodiment of the present disclosure;

FIG. 3 is a flowchart of an address book maintenance method according to an embodiment of the present disclosure; and

FIG. 4 is a group address book management platform according to an embodiment of the present disclosure.

### DETAILED DESCRIPTION

To make the objectives, technical solutions, and advantages of the present disclosure clearer, the embodiments of the present disclosure are described in detail below with reference to the accompanying drawings.

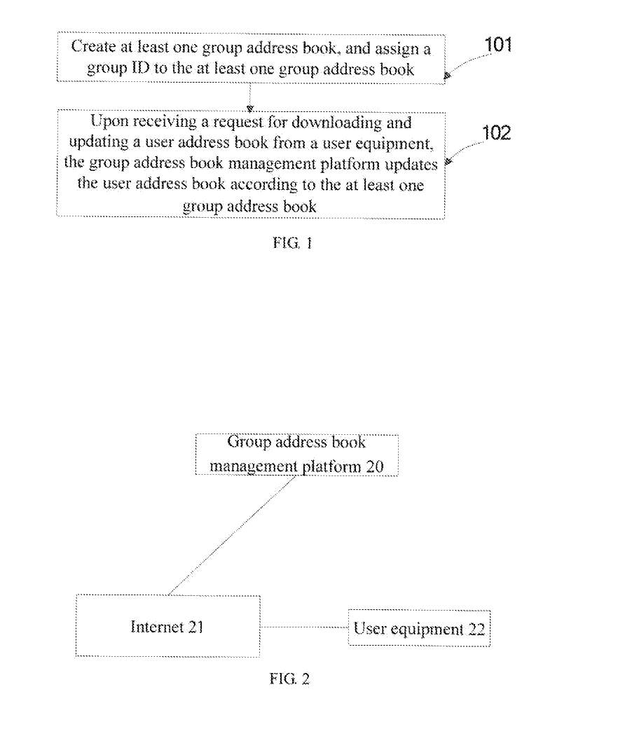

Referring to FIG. 1, an embodiment of the present disclosure provides an address book maintenance method. The method specifically includes the following steps:

Step 101: A group address book management platform creates at least one group address book, and assigns a group ID to the at least one group address book.

Step 102: Upon receiving a request for downloading and updating a user address book from a user equipment, the group address book management platform updates the user address book according to the at least one group address book.

According to the technical solutions disclosed in the present disclosure, at least one group address book is created, and a group ID is assigned to the at least one group address book; after a request for downloading and updating a user address book is received from a user equipment, the user address book is updated according to the created at least one group address book, such that users can quickly and conveniently manage and update the address book. In this way, a solution of downloading and synchronizing at least one group address book to the address book of a user equipment such as mobile phone, tablet computer, and personal computer is provided.

FIG. 2 illustrates network architecture according to an embodiment of the present disclosure. A group address book management platform 20 is pre-deployed by a vendor, and is connected to a user equipment 22 over an Internet network 21, providing a function of creating and maintaining a group address book for a user. Herein, the group address book management platform 20 may be a software system for managing group address books, and may be separately deployed by an address book provider, or may be deployed by an address book provider onto an existing network server, for example, an email server, a QQ server, or an SNS server. In addition, the group address book management platform 20 further provides a registration function for a user to join the group address book management platform 20, such that a registered user is capable of creating and maintaining a group address book over the group address book management platform 20. Further, the group address book management platform 20 may further acquire desired creation information from the Internet network 21 during creating and maintaining the group address book. After the user equipment 22 logs in to the group address book management platform 20, the group address book management platform 20 maintains (for example, update, modify, or delete operation), according to the maintained group address book, an address book stored on the user equipment 22.

It should be noted that the user equipment 22 according to this embodiment is a built-in address book for which a function of synchronizing the group address book on the group address book management platform 20 is preconfigured, or a client program for which an address book function of the group address book management platform 20 is preconfigured. The user equipment 22 may be specifically a user device such as a mobile phone, a tablet computer, or a personal computer.

The user equipment 22 may send a request for downloading and updating a address book stored thereon by using the built-in address book for which the function of synchronizing the group address book on the group address book management platform 20 is preconfigured, or the client program for which the address book function of the group address book management platform 20 is preconfigured. Upon receiving the request from the user equipment 22, the group address book management platform 20 downloads and updates the address book stored on the user equipment 22.

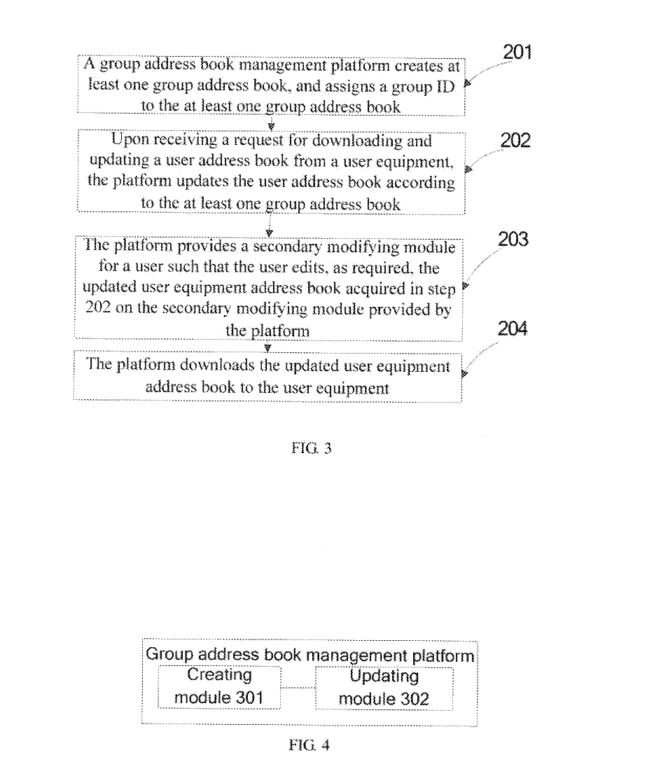

Referring to FIG. 3, an address book maintenance method is provided. The execution subject of the method corresponds to the group address book management platform 20 (hereinafter referred to as platform). The method specifically includes the following steps:

Step 201: The platform creates at least one group address book, and assigns a group ID to the at least one group address book.

Specifically, group creation information of the at least one group address book is acquired, the at least one group address book is created according to the group creation information, and the group ID is assigned to the at least one group address book, where the group creation information may include group type, group name, and group brief introduction.

A member is added to the at least one group address book, and contact information of the added member is recorded and maintained, where the contact information may include member name, telephone number, instant messaging account, email account, Weibo account, or/and SNS account. During specific implementation, the method described in this step includes the following operations:

Step 201-1: A user sends a request for creating a group address book to the platform, where the user has registered on the platform.

Specifically, the user logs in to the platform; after login information of the user is successfully verified by the platform, the user sends the request for creating a group address book to the platform over an interface provided by the platform for creating a group address book. The login information may include login account and password, where the login account may be: an instant messaging (IM) account, an SNS account, a Weibo account, a personal email account, an enterprise email account, or a self-defined account; the IM account includes instant messaging accounts such as QQ account, MSN account and Baidu Hi account; and the SNS account includes Renren account and Kaixin account.

In addition, the platform provides a registration function for the user. If an unregistered user desires to create a group address book, the unregistered user needs to firstly register on the platform, and then log in to the platform. After login, the user is capable of sending a request for creating a group address book to the platform by using the method in step 201-1.

For example, Zhang San registers on the platform and becomes a registered user on the platform; in this case, Zhang San is capable of sending a request for creating a group address book by clicking the option “create new group address book” on the foreground of the platform.

Step 201-2: Upon receiving the request for creating a group address book from the user, the platform acquires group creation information of the group address book, and creates the group address book according to the acquired group creation information; where the group creation information includes group type, group name, brief group introduction, and the like.

Specifically, upon receiving the request for creating a group address book from the user, the platform skips to an interface for entering group creation information and prompting the user to enter the group creation information, where the interface provides a group creation information input interface; the user inputs the group creation information over the interface displayed for entering group creation information; the platform creates a new group address book according to the received group creation information.

For example, upon receiving a request for creating a group address book from Zhang San, the platform skips to an interface for entering group creation information and prompting Zhang San to enter such group creation information as group type, group name, and group brief introduction; Zhang San inputs group type “ordinary group”, group name “Class 1 Grade 3 in No. 1 Middle School”, and group brief introduction “contact information of classmates in Class 1 Grade 2009 in No. 1 Middle School” over the interface displayed for entering group creation information; and the platform creates a group address book named “Class 1 Grade 3 in No. 1 Middle School” according to the received group creation information.

Step 201-3: The platform assigns a group ID to the created group address book, and each group address book on the platform is identified by its corresponding group ID.

By repeating steps 201-1 to 201-3, the platform is capable of creating one to a plurality of group address books. For example, in this embodiment, the platform creates three group address books, i.e., group address book named “Class 1 Grade 1 in No. 1 Middle School” with group ID 0001, and group address book named “Wireless Research and Development Department in xxx Technologies Inc.” with group ID 0010.

Herein, by default, the content of the group address books created in steps 201-1 to 201-3 is blank or only includes contact information of the creator. For example, the group address book named “Class 1 Grade 3 in No. 1 Middle School” only includes contact information of the creator Zhang San. This is because the group address book is created by Zhang San, and the platform can easily acquire the contact information of Zhang San, and adds the acquired contact information to the created group address book.

Step 201-4: The platform adds members to the created group address books, and records and maintains contact information of the added members, where the contact information may be: member name (for example, real name or/and nickname of the member), telephone number, IM account, email account, Weibo account or/and SNS account or the like.

Specifically, a member may be added to the created group address book in the following three manners:

Manner 1: The platform waits to receive a request for joining a created group address book from a member; upon receiving the request, if the request carries the group ID of the created group address book, the platform adds the member to the created group address book, acquires contact information of the member, and records and maintains the contact information of the member; upon receiving the request, if the request carries the group ID of the created group address book and the contact information of the member, the platform adds the member to the created group address book, and records and maintains the contact information of the member.

During specific implementation, the member determines a group address book to join by searching for the group ID or/and group brief introduction, and sends a request for joining the group address book to the platform, where the request carries the group ID of the group address book to join; and upon receiving the request for joining the group address book, the platform adds the member sending the request to the group address book identified by the group ID according to the group ID carried in the request.

Furthermore, before adding the member sending the request to the group address book identified by the group ID according to the group ID carried in the request, the platform verifies the member sending the request for joining the group address book (for example, verifying the identity of the member sending the request by using a routine identity verification method), and adds the member to the group address book identified by the group ID according to the group ID carried in the request after the verification is successful.

Herein, in addition to the group ID, the request for joining the group address book sent by the member to the platform may further carry the contact information of the member. In this way, the platform adds the member sending the request to the group address book identified by the group ID, and records the contact information of the member carried in the request.

Such processing is advantageous in that: The member is capable of pre-editing his or her contact information; in this way, when being added to different group address books, a member may be quickly added to the group address books according to the pre-edited contact information, and the same contact information may be detected in all group address books to which the member is added.

In addition, the request for joining the group address book sent by the member to the platform only includes the group ID. In this way, the platform adds the member sending the request to the group address book identified by the group ID, and prompts the member to edit his or her contact information; and the platform stores the received contact information edited by the member into the group address book.

Such processing is advantageous in that: When being added to the group address book, the member temporarily edits his or her contact information; in this way, the member may set different contact information in different group address books to which the member is added.

For example, Li Si graduated from Class 1 Grade 3 in No. 1 Middle School searches for the group ID and the corresponding group brief introduction, and finds that the group address book with group ID 0001 records “contact information of classmates in Class 1 Grade 2009 in No. 1 Middle School”. Li Si was just one from Class 1 Grade 2009 in No. 1 Middle School, and therefore he sends a request for joining the group address book with group ID 0001 to the platform. If Li Si is added to the group address book by the platform, he is capable of acquiring contact information of the members in the group address book and his contact information may also be acquired by the members in the group address book. Herein, the request for joining the group address book with group ID 0001 sent by Li Si to the platform carries his contact information. Upon receiving the request, the platform adds Li Si to the group address book with group ID 0001, and records the contact information carried in the request.

Manner 2: The platform sends an invite message to a member to join the group address book as an invitation to join the group address book, and waits to receive an invite accept message from the member; upon receiving the invite accept message, the platform adds the member to the group address book, and acquires contact information of the member, and records and maintains the contact information of the member; and upon receiving the accept request, if the accept request carries the contact information of the member, the platform adds the member to the group address book, and records and maintains the contact information of the member.

During specific implementation, an address book manager invites, over the platform, his known member to join the group address book where the address book manager is located, where the address book manager is specified by the creator of the group address book; the platform forwards the invite message sent by the address book manager to the corresponding members, where the invite message carries the group ID of the group address book to which the member is invited to join; upon receiving the invite message, the member determines whether to accept the invitation, and if determining to accept the invitation, sends an invite accept message to the platform, where the invite accept message carries contact information of the member; and upon receiving the invite accept message from the member, the platform adds the member successfully invited over the invite accept message to the group address book.

Herein, if the invite accept message carriers the contact information of the member, in addition to adding the member successfully invited over the invite accept message to the group address book, the platform records the contact information carried in the invite accept message.

Such processing is advantageous in that: The member is capable of pre-editing his or her contact information; in this way, when being added to different group address books, a member may be quickly added to the group address books according to the pre-edited contact information, and the same contact information may be detected in all group address books to which the member is added.

In addition, if the invite accept message does not carries the contact information of the member, in addition to adding the member successfully invited over the invite accept message to the group address book, the platform prompts the member to edit his or her contact information, and stores the received contact information edited by the member into the group address book.

Such processing is advantageous in that: When being added to the group address book, the member temporarily edits his or her contact information; in this way, the member may set different contact information in different group address books to which the member is added.

For example, a manager of the group address book with group ID 0001 is Li Si, and the manager Li Si is specified by the creator of the group address book; Li Si sends an invite message to his classmates Ma Yi, Wang Wu, and Mary who were ever in Class 1 Grade 2009 in No. 1 Middle Scholl, to invite them to join the group address book with group ID 0001; upon receiving the invite message, if determining to join the group address book, Ma Yi, Wang Wu, and Mary send an invite accept message to the platform; upon receiving the invite accept message, the platform adds Ma Yi, Wang Wu, and Mary to the group address book with group ID 0001, prompts them to input their contact information, and subsequently adds contact information acquired therefrom into the group address book.

It should be noted that the member added to the group address book by using manners 1 and 2 is a “real member” in this embodiment.

Manner 3: Information of the member to join the group address book is searched over the Internet, the member to join the group address book is added into the group address book and the acquired information is recorded and maintained.

During specific implementation, the platform creates an address book item for a member in the created group address book, and contact information of the address book item of the member at least includes member name. Herein, the member added to the group address book is not actually added to the group address book, but only occupies a part of memory and includes partial contact information. In this embodiment, such member is referred to as a “virtual member”. The platform acquires partial contact information of the “virtual member” by associated searching over the Internet.

For example, the platform creates two address book items in the group address book “Class 1 Grade 3 in No. 1 Middle School”, and the two address book items respectively correspond to students “Lu Jiayi” and “Lu Hongfeng” in Class 1 Grade 2009 in No. 1 Middle School. If inviting these two students to join the group address book “Class 1 Grade 3 in No. 1 Middle School” by using the manner described in step 201-4A or 201-4B fails (for example, “Lu Jiayi” and “Lu Hongfeng” refuse to join the group address book), “Lu Jiayi” and “Lu Hongfeng” in the group address book are referred to as “virtual members”.

Still for example, the platform creates two address book items in the group address book “Class 1 Grade 3 in No. 1 Middle School”, and the two address book items correspond to students “Lu Jiayi” and “Lu Hongfeng” in Class 1 Grade 2009 in No. 1 Middle School. The target information for acquisition is restricted to the two names “Lu Jiayi” and “Lu Hongfeng”, with other information unknown. In this case, the platform searches for, over the Internet, all association information related to “Lu Jiayi” and “Lu Hongfeng”, and extracts from the association information a message indicating that “Lu Jiayi” and “Lu Hongfeng” change from “virtual members” to “real members”, for example, QQ accounts of “Lu Jiayi” and “Lu Hongfeng”, and invites, by using the acquired QQ accounts, “Lu Jiayi” and “Lu Hongfeng” to join the group address book.

By using the method described in step 201-4, the platform may add a member to any of the created group address books. FIG. 3 is a schematic diagram of the content of the group address book “Class 1 Grade 3 in No. 1 Middle School”, which includes 10 “real members” and 10 “virtual members”.

Step 201-5: The platform maintains the contact information of the member in the created group address book, for example, adding, modifying, or deleting contact information of a member.

Specifically, the “real member” in the group address book maintains, over the platform, the contact information in the group address book at which he or she is located; in addition, the “real member” may also grant or restrict the manager of the group address book in maintaining his or her contact information over the platform; the platform stores contact information maintained by both “real member” and manager of the group address book.

Alternatively, the manager of the group address book maintains contact information thereof, contact information of the “virtual member”, and contact information of the “real member” for which modification is allowed; the platform stores the contact information maintained by the manager in the group address book.

For example, the “real member” Li Si in the group address book “Class 1 Grade 3 in No. 1 Middle School” modifies his contact information “QQ account 414148020”, “telephone number 01051238420”, and “email address 1123@163.com” to “QQ account 414148020”, “telephone number 01051238420”, and “email address 1123@sohu.com”; and the platform stores “QQ account 414148020”, “telephone number 01051238420”, and “email address 1123@sohu.com” as the contact information of the “real member” Li Si in the group address book “Class 1 Grade 3 in No. 1 Middle School”.

Step 202: Upon receiving a request for downloading and updating a user address book from a user equipment, the platform updates the user address book according to the at least one group address book.

Specifically, the user equipment sends a request for downloading and updating a user address book to the platform by using a built-in address book having a group address book function of the platform, or by using a client program having an address book function of the platform, where the user equipment may send the request for downloading and updating the user address book by using manual mode or by using automatic mode with specified rules, and may be associated with the platform by using the platform account and password.

Specifically, in this embodiment, the user address book is updated according to the created group address book in the following two manners:

Manner 1: The user address book is copied; a group address book to be downloaded is determined from the created group address books; the group address book to be downloaded is combined with a copy of the user address book; and the combined address book is downloaded to the user equipment.

It should be noted that the platform further provides a secondary editing function for the copy of the user address book, for example, providing a secondary modifying module for the user, such that the user equipment can edit the contact information in the user address book copied on the platform by using the secondary modifying module on the platform, for example, adding comments, modifying name, and adding more contact information.

The determining a group address book to be downloaded from the created group address books includes:

determining, by the user equipment, a group address book to be downloaded by searching for the group ID or/and the corresponding group brief introduction, and sending a request for downloading and updating a group address book, where the request carries the group ID of the group address book to be downloaded; upon receiving the request, determining, by the platform, a group address book to be downloaded from the created group address books according to the group ID carried in the request.

For example, Zhang San graduated from Class 1 Grade 3 in No. 1 Middle School searches for the group ID and the corresponding group brief introduction, and finds that the group address book with group ID 0001 records “contact information of classmates in Class 1 Grade 2009 in No. 1 Middle School”. Zhang San was just one from Class 1 Grade 3, 2009 in No. 1 Middle School, and therefore he sends a request for joining the group address book with group ID 0001 to the platform, such that he can download the group address book to his own address book. In addition, Zhang San searches the group ID and the corresponding group brief introduction, and finds that the group address book with ID 0010 records “contact information of members in the Wireless Research and Development Department in xxx Technologies Inc.”. Zhang San is currently a new employee in the department of this company, and therefore, he sends a request for joining the group address book with group ID 0010, such that he can download the group address book to his own address book.

The combining the group address book to be downloaded with the copy of the user address book includes: comparing contact information of each member in the group address book to be downloaded with contact information of each member in the copy; combining the group address book to be downloaded into the copy according to a preset rule if the group address book to be downloaded includes a member having the same member name as a member in the copy; and combining the group address book to be downloaded into the copy if the group address book to be downloaded does not include a member having the same member name as a member in the copy.

Specifically, the combining the group address book to be downloaded into the copy according to a preset rule if the group address book to be downloaded comprises a member having the same member name as a member in the copy includes:

combining a member in the group address book to be downloaded having a different member name as a member in the copy into the copy; according to contact information of the member in the group address book to be downloaded having the same member name as the member in the copy, updating contact information of the member in the copy having the same member name as the member in the group address book to be downloaded, or not updating contact information of the member in the copy having the same member name as the member in the group address book to be downloaded, or creating communication information for the member in the copy having the same member name as the member in the group address book to be downloaded according to contact information of the member in the group address book to be downloaded having the same member name as the member in the copy.

For example, the platform compares members in a copy of Zhang San's address book with members in the group address book “Class 1 Grade 3 in No. 1 Middle School” and members in the group address book “Wireless Research and Development Department in xxx Technologies Inc.” respectively, and finds that other contact information of the member Li Si in the copy includes “QQ account 123456”, “mobile phone number 15201012345”, and “nickname Little A”; the contact information of Li Si in the group address book “Class 1 Grade 3 in No. 1 Middle School” includes “QQ account 123456”, “”mobile phone number 15201012345”, “telephone number 01051238430”,and “nickname Little A”, and the contact information of Li Si in the group address book “Wireless Research and Development Department in xxx Technologies Inc.” includes “QQ account 123456”, “email address 123456@qq.com”, and “nickname Little A”. Herein, by creating new contact information, the platform updates the contact information of Li Si in the copy of the user address book to ““QQ account 123456”, ““mobile phone number 15201012345”, “telephone number 01051238430”, “email address 123456@qq.com”, and “nickname Little A”.

Still for example, the user equipment Li Si searches for the group ID and the corresponding group brief introduction, and finds that the group address book with group ID 0001 records “contact information of classmates in Class 1 Grade 2009 in No. 1 Middle School”. Li Si was just one from Class 1 Grade 2009 in No. 1 Middle School, and therefore he sends a request for adding the group address book with group ID 0001 to the platform, so as to add that group address book to his own address book. In this way, Li Si can add contact information of all classmates in Class 1 Grade 2009 in No. 1 Middle School to his address book. Upon receiving the request, the platform adds all contact information in the group address book with group ID 0001 to the copy of the user address book.

Manner 2: A group address book to be downloaded is determined from the created group address books; the group address book to be downloaded is downloaded to the user equipment, such that the user equipment combines the group address book to be downloaded with the user address book.

The implementation of determining the group address book to be downloaded from the created group address books is identical to that described in manner 1, which is thus not described herein any further.

The method using which the user equipment combines the group address book to be downloaded with the user address book is identical to the method using which the platform combines the group address book to be downloaded with the user address book, which is thus not described herein any further.

Herein, during specific implementation of this embodiment, prior to the downloading the combined address book to the user equipment, the method further includes: editing contact information of members in the combined address book.

Step 203: The platform provides a secondary modifying module for a user such that the user edits, as required, the updated user equipment address book acquired in step 202 on the secondary modifying module provided by the platform.

Step 204: The platform downloads the updated user equipment address book to the user equipment.

According to the technical solutions disclosed in the present disclosure, at least one group address book is created, and a group ID is assigned to the at least one group address book; after a request for downloading and updating a user address book is received from a user equipment, the user address book is updated according to the created at least one group address book, such that users can quickly and conveniently manage and update the address book. In this way, a solution of downloading and synchronizing at least one group address book to the address book of such a user equipment as mobile phone, tablet computer, and personal computer.

In addition, the technical solutions according to the present disclosure provide competitive functions for the product: in addition to synchronization of a personal address book on such a mobile device as a mobile phone, tablet computer, and personal computer, achieving synchronization of a group address book thereon; provide quick propagation for sales: focusing on some opinion leaders to create users in a plurality of groups; and provides enhanced product viscosity: adding multiple layers of group relationships for the users on the address book platform, and improving abandon cost of the users while enhancing the user viscosity. The technical solutions may be integrated into a product in a plurality of forms, for example, personal IM (including IM groups), SNS, enterprise service, personal address book, synchronization assistant, email client, and the like, thereby greatly expanding the original product application.

Referring to FIG. 4, an embodiment of the present disclosure provides a group address book management platform is provided. The platform specifically corresponds to the platform in the method embodiments, including: a creating module 301 and an updating module 302.

The creating module 301 is configured to create at least one group address book, and assign a group ID to the at least one group address book.

The updating module 302 is configured to: upon receiving a request for downloading and updating a user address book from a user equipment, update the user address book according to the at least one group address book created by the creating module 301.

The creating module 301 includes:

a creating unit, configured to acquire creation information of at least one group address book, create the at least one group address book according to the group creation information, and assign the group ID to the at least one group address book, where the group creation information may include group type, group name, and group brief introduction; and

an adding unit, configured to add a member to the at least one group address book created by the creating unit, and record and maintain contact information of the added member, where the contact information may include member name, telephone number, instant messaging account, email account, Weibo account, or/and SNS account.

The adding unit includes:

a first receiving subunit, configured to wait to receive a request for joining the at least one group address book from a member to join the group address book;

a first adding subunit, configured to: after the first receiving subunit receives the request, if the request carries the group ID of the at least one group address book, add the member to the at least one group address book, acquire contact information of the member, and record and maintain the contact information of the member; and

a second adding subunit, configured to: after the first receiving subunit receives the request, if the request carries the group ID of the at least one group address book and the contact information of the member, add the member to the at least one group address book, and record and maintain the contact information of the member; and

The adding unit may further include:

a sending subunit, configured to send an invite message as an invitation to join the group address book to a member to join the group address book;

a second receiving subunit, configured to wait to receive an invite accept message from the member;

a third adding subunit, configured to: after the second receiving subunit receives the invite accept message, add the member to the at least one group address book, acquire contact information of the member, and record and maintain the contact information of the member; and

a fourth adding subunit, configured to: after the second receiving subunit receives the invite accept message, if the invite accept message comprises the contact information of the member, add the member to the at least one group address book, and record and maintain the contact information of the member;

The adding unit may further include:

a searching subunit, configured to search for, over the Internet, information of a member to join the at least one group address book; and

a fifth adding subunit, configured to add the member to the at least one group address book, and record and maintain the information searched out by the searching subunit.

The updating module 302 includes:

a determining unit, configured to determine a group address book to be downloaded from the at least one group address book;

a first downloading and updating unit, configured to download the group address book to be downloaded to the user equipment, such that the user equipment combines the group address book to be downloaded with the user address book;

The updating module 302 may further include:

a copying unit, configured to copy the user address book;

a determining unit, configured to determine a group address book to be downloaded from the at least one group address book;

a combining unit, configured to combine the group address book to be downloaded that is determined by the determining unit with a copy of the user address book acquired by the copying unit; and

a second downloading and updating unit, configured to download the combined address book to the user equipment.

The combining unit includes:

a comparing subunit, configured to compare contact information of each member in the group address book to be downloaded with contact information of each member in the copy;

a first combining subunit, configured to combine the group address book to be downloaded into the copy according to a preset rule if the group address book to be downloaded comprises a member having the same member name as a member in the copy; and

a second combining subunit, configured to combine the group address book to be downloaded into the copy if the group address book to be downloaded does not comprise a member having the same member name as a member in the copy.

The first combining subunit is specifically configured to: combine a member in the group address book to be downloaded having a different member name as a member in the copy into the copy; according to contact information of the member in the group address book to be downloaded having the same member name as the member in the copy, update contact information of the member in the copy having the same member name as the member in the group address book to be downloaded, or not update contact information of the member in the copy having the same member name as the member in the group address book to be downloaded, or create communication information for the member in the copy having the same member name as the member in the group address book to be downloaded according to contact information of the member in the group address book to be downloaded having the same member name as the member in the copy.

The platform further includes: a secondary modifying module, configured to edit contact information of members in the combined address book.

The technical solutions according to the present disclosure create the following beneficial effects:

According to the technical solutions disclosed in the present disclosure, at least one group address book is created, and a group ID is assigned to the at least one group address book; after a request for downloading and updating a user address book is received from a user equipment, the user address book is updated according to the created at least one group address book, such that users can quickly and conveniently manage and update the address book. In this way, a solution of downloading and synchronizing at least one group address book to the address book of such a user equipment as mobile phone, tablet computer, and personal computer.

In addition, the technical solutions according to the present disclosure provide competitive functions for the product: in addition to synchronization of a personal address book on such a mobile device as a mobile phone, tablet computer, and personal computer, achieving synchronization of a group address book thereon; provide quick propagation for sales: focusing on some opinion leaders to bring users in a plurality of groups; and provides enhanced product viscosity: adding multiple layers of group relationships for the users on the address book platform, and improving abandon cost of the users while enhancing the user viscosity. The technical solutions may be integrated into a product in a plurality of forms, for example, personal IM (including IM groups), SNS, enterprise service, personal address book, synchronization assistant, email client, and the like, thereby greatly expanding the original product application.

The method embodiment and the platform embodiment according to the present disclosure may be referenced to each other. Especially, since the entire process has been described in detail in the method embodiment, some related details are not further described in the platform embodiment, which may be referenced to the method embodiment.

Persons of ordinary skill in the art should understand that all or part of steps of the preceding methods may be implemented by hardware or hardware following instructions of programs. The programs may be stored in a computer readable storage medium and may be executed by at least one processor. The storage medium may be a read only memory, a magnetic disk, or a compact disc-read only memory.

Described above are merely preferred embodiments of the present disclosure, but are not intended to limit the present disclosure. Any modification, equivalent replacement, or improvement made without departing from the spirit and principle of the present disclosure should fall within the protection scope of the present disclosure.

1-20. (canceled)

21. An address book maintenance method, comprising:
creating, by a group address book management platform, at least one group address book;
assigning a group ID to the at least one group address book; and
upon receiving a request for downloading and updating a user address book from a user equipment, updating, by the group address book management platform, the user address book according to the at least one group address book.

22. The method according to claim 21, wherein the creating, by a group address book management platform, at least one group address book, and assigning a group ID to the at least one group address book comprises:
acquiring, by the group address book management platform, group creation information of the at least one group address book;
creating the at least one group address book according to the group creation information, and assigning the group ID to the at least one group address books; and
adding, by the group address book management platform, a member to the at least one group address book, and recording and maintaining contact information of the added member.

23. The method according to claim 22, wherein the adding, by the group address book management platform, a member to the at least one group address book, and recording and maintaining contact information of the added member comprises:
waiting to receive, by the group address book management platform, a request for joining the at least one group address book from a member; upon receiving the request, if the request carries the group ID of the at least one group address book, adding, by the group address book management platform, the member to the at least one group address book, acquiring contact information of the member, and recording and maintaining the contact information of the member; and upon receiving the request, if the request caries the group ID of the at least one group address book and the contact information of the member, adding, by the group address book management platform, the member of the at least one group address book, and recording and maintaining the contact information of the member.

24. The method according to claim 22, wherein the adding, by the group address book management platform, a member to the at least one group address book, and recording and maintaining contact information of the added member comprises:
sending, by the group address book management platform, an invite message as an invitation to join the at least one group address book to a member to join the group address book, and waiting to receive an invite accept message from the member upon receiving the invite accept message, adding, by the group address book management platform, the member to the at least one group address book, acquiring contact information of the member, and recording and maintaining the contact information of the member; and upon receiving the invite accept message, if the invite accept message comprises the contact information of the member, adding, by the group address book management platform, the member to the at least one group address book, and recording and maintaining the contact information of the member.

25. The method according to claim 22, wherein the adding, by the group address book management platform, a member to the at least one group address book, and recording and maintaining contact information of the added member comprises:
searching for, by the group address book management platform, over the Internet, information of a member to join the at least one group address book; adding, by the group address book management platform, the member to the at least one group address book, and recording and maintaining the searched information.

26. The method according to claim 22, wherein the upon receiving a request for downloading and updating a user address book from a user equipment, updating, by the group address book management platform, the user address book according to the at least one group address book comprises:
determining, by the group address book management platform, a group address book to be downloaded from the at least one group address book; and downloading, by the group address book management platform, the group address book to be downloaded to the user equipment, such that the user equipment combines the group address book to be downloaded with the user address book.

27. The method according to claim 22, wherein the upon receiving a request for downloading and updating a user address book from a user equipment, updating, by the group address book management platform, the user address book according to the at least one group address book comprises:
copying, by the group address book management platform, the user address book; determining, by the group address book management platform, a group address book to be downloaded from the at least one group address book; combining, by the group address book management platform, the group address book to be downloaded with a copy of the user address book; and downloading, by the group address book management platform, the combined address book to the user equipment.

28. The method according to claim 27, wherein the combing, by the group address book management platform, the group address book to be downloaded with the copy of the user address book comprises:
comparing, by the group address book management platform, contact information of each member in the group address book to be downloaded with contact information of each member in the copy;
combining, by the group address book management platform, the group address book to be downloaded into the copy according to a present rule if the group address book to be downloaded comprises a member having the same member name as a member in the copy; and
combining, by the group address book management platform, the group address book to be downloaded into the copy if the group address book to be downloaded does not comprise a member having the same member name as a member in the copy.

29. The method according to claim 28, wherein the combining, by the group address book management platform, the group address book to be downloaded into the copy according to a preset rule if the group address book to be downloaded comprises a member having the same member name as a member in the copy comprises:
combining, by the group address book management platform, a member in the group address book to be downloaded having a different member name as a member in the copy into the copy; and
according to contact information of the member in the group address book to be downloaded having the same member name as the member in the copy, updating, by the group address book management platform, contact information of the member in the copy having the same member name as the member in the group address book to be downloaded, or not updating contact information of the member in the copy having the same member name as the member in the group address book to be downloaded, or creating communication information for the member in the copy having the same member name as the member in the group address book to be downloaded according to contact information of the member in the group address book to be downloaded having the same member name as the member in the copy.

30. The method according to claim 21, wherein prior to the downloading, by the group address book management platform, the combined address book to the user equipment, the method further comprises: editing contact information of members in the combined address book.

31. A group address book management platform, comprising:
a creating module configured to create at least one group address book, and assign a group ID to the at least one group address book; and
a updating module configured to: upon receiving a request for downloading and updating a user address book form a user equipment, update the user address book according to the at least one group address book.

32. The platform according to claim 31, wherein the creating module comprises:
a creating unit, configured to acquire group creating information of the at least one group address book, create the at least one group address book according to the group creation information, and assign the group ID to the at least one group address books; and
an adding unit, configured to add a member to the at least one group address book, and record and maintain contact information of the added member.

33. The platform according to claim 32, wherein the adding unit comprises:
a first receiving subunit, configured to wait to receive a request for joining the at least one group address book from a member to join the group address book;
a first adding subunit, configured to: after the first receiving subunit receives the request, if the request carries the group ID of the at least one group address book, add the member to the at least one group address book, acquire contact information of the member, and record and maintain the contact information of the member; and
a second adding subunit, configured to: after the first receiving subunit receives the request, if the request carries the group ID of the at least one group address book and the contact information of the member, add the member to the at least one group address book, and record and maintain the contact information of the member.

34. The platform according to claim 32, wherein the adding unit comprises:
a sending subunit, configured to send an invite message as an invitation to join the at least one group address book to a member join the group address book;
a second receiving subunit, configured to wait to receive an invite accept message from the member;
a third adding subunit, configured to: after the second receiving subunit receives the invite accept message, add the member to the at least one group address book, acquire contact information of the member, and record and maintain the contact information of the member; and
a fourth adding subunit, configured to: after the second receiving subunit receives the invite accept message, if the invite accept message comprises the contact information of the member, add the member to the at least one group address book, and record and maintain the contact information of the member.

35. The platform according to claim 32, wherein the adding unit comprises:
a searching subunit, configured to search for, over the Internet, information of a member to join the at least one group address book; and
a fifth adding subunit, configured to add the member to the at least one group address book, and record and maintain the information searched out by the searching subunit.

36. The platform according to claim 32, wherein the updating module comprises:
a determining unit, configured to determine a group address book to be downloaded from the at least one group address book; and
a first downloading and updating unit, configured to download the group address book to be downloaded to the user equipment, such that the user equipment combines the group address book to be downloaded with the user address book.

37. The platform according to claim 32, wherein the updating module comprises:
a copying unit, configured to copy the user address book;
a determining unit, configured to determine a group address book to be downloaded from the at least one group address book;
a combining unit, configured to combine the group address book to be downloaded that is determined by the determining unit with a copy of the user address book acquired by the copying unit; and
a second downloading and updating unit, configured to download the combined address book to the user equipment.

38. The platform according to claim 37, wherein the combining unit comprises:
a comparing subunit, configured to compare contact information of each member in the group address book to be downloaded with contact information of each member in the copy;
a first combining subunit, configured to combine the group address book to be downloaded into the copy according to a preset rule if the group address book to be downloaded comprises a member having the same member name as a member in the copy; and
a second combining unit, configured to combine the group address book to be downloaded into the copy of the group address book to be downloaded does not comprise a member having the same member name as a member in the copy.

39. The platform according to claim 38, wherein the first combining subunit is specifically configured to: combine a member in the group address book to be downloaded having a different member name as a member in the copy into the copy; according to contact information of the member in the group address book to be downloaded having the same member name as the member in the copy, update contact information of the member in the copy having the same member name as the member in the group address book to be downloaded, or not update contact information of the member in the copy having the same member name as the member in the group address book to be downloaded, or create communication information for the member in the copy having the same member name as the member in the group address book to be downloaded according to contact information of the member in the group address book to be downloaded having the same member name as the member in the copy.

40. The platform according to claim 31, further comprising a secondary modifying module, configured to edit contact information of members in the combined address book.
